(19) United States
(12) Patent Application Publication
(10) Pub. No.: US 2014/0124121 A1
(43) Pub. Date: May 8, 2014

(54) MANUFACTURE METHOD OF TOUCH AND DISPLAY DEVICE

(71) Applicant: INTERFACE OPTOELECTRONICS CORPORATION, (US)

(72) Inventor: Chien-Erh WANG, Shenzhen (TW)

(73) Assignee: INTERFACE OPTOELECTRONICS CORPORATION, Shenzhen (CN)

(21) Appl. No.: 13/719,247

(22) Filed: Dec. 19, 2012

(30) Foreign Application Priority Data
Nov. 5, 2012 (CN) 201210436245.X

(51) Int. Cl. G06F 3/041

(52) U.S. Cl. CPC G06F 3/041
USPC 156/64; 156/60

(57) ABSTRACT

A manufacture method of a touch and display device includes following acts. An open cell is provided. A touch panel with a protection film is provided. The open cell and the touch panel with the protection film are laminated to form a touch and display panel. A backlight unit is assembled, and then the backlight unit is integrated with the touch and display panel using a liquid crystal display module to form a touch and display device.

### RELATED APPLICATIONS

This application claims priority to China Application Serial Number 201210436245.X, filed Nov. 5, 2012, which is herein incorporated by reference.

### BACKGROUND

1. Field of Invention

The invention relates to a manufacture method of a touch and display device.

2. Description of Related Art

With the development of the scientific and technological industry, the personal desire is becoming stronger and stronger in receiving information without delay, so that the market of the personalized scientific and technological products, such as the smart phone, the tablet computer and the notebook computer, are being expanded greatly. In particular, the display device with a touch panel becomes the main trend for current scientific and technological products since a user can input signals by directly touching the touch panel with a finger or a touch pen, which accelerates the information processing speed for the user.

The existing touch and display device includes the tablet computer, the notebook computer, the smart phone, the handheld device and so on, each of which consists of multiple components, for example mainly consisting of a display device, a touch device, a camera lens and other components. The combination of the display device and the touch device is referred to as a touch and display panel, which mainly consists of an open cell, a touch panel, a backlight unit and so on. The touch panel may be first attached to the open cell, and then is co-assembled with the backlight unit. However, the conventional tablet computer, notebook computer, smart phone, handheld device and so on each consists of various different electronic components such as a housing case, a camera lens, a touch panel, a display panel and the to backlight unit, and generally these components are first manufactured separately in different workshops and then are delivered to a same workshop to be assembled. Therefore, in any one of the manufacture periods, at least quality control zones should be arranged both for components incoming and leaving the factory, so as to ensure the quality of each component, and in order to ensure the final quality of the product, at the client end a quality control person should be employed to ensure the quality of the product accordingly to cooperate with the quality control at the factory end. In view of the above, since corresponding quality control persons should be employed to manage respective quality control zones of respective components manufactured in respective factories, it means that the cost of labour power and inspection tools are increased accordingly in both the factory end and the client end, which is a heavy burden for quality control and manufacture cost at the manufacturing end.

### SUMMARY

According to an embodiment of the invention, a manufacture method of a touch and display device includes the following acts (it should be understood that, the acts stated in this embodiment can be adjusted in performance sequence according to actual need, or even all or parts of these acts can be performed simultaneously, unless otherwise the performance sequence thereof is stated specially).

An open cell is provided.

A touch panel with a protection film is provided.

The open cell and the touch panel with the protection film are laminated to form a touch and display panel.

A backlight unit (BLU) is assembled, and then the backlight unit is integrated with the touch and display panel using a liquid crystal display module to form a touch and display device.

In one or more embodiments, the above act of providing the open cell further includes the following acts:

first performing an incoming quality inspection on an open cell chip incoming the factory, wherein the open cell chip incoming the factory is a cut open cell chip attached with a driving chip, a flexible printed circuit board and a printed circuit board; and

then unpacking the quality inspected open cell chip incoming the factory so as to wait to laminate the open cell chip with the touch panel with the protection film.

In one or more embodiments, the above act of providing the open cell further includes the following acts:

first performing an incoming quality inspection on an open cell substrate incoming the factory, wherein the open cell substrate incoming the factory is an uncut open cell substrate;

then cutting, edging and cleaning the quality inspected open cell substrate incoming the factory, and then pasting a polarizer thereon; and

subsequently performing the anisotropic conductive film (ACF) paste, chip on glass process, chip on film process, printed circuit board (PCB) lamination, and silicon coating in sequence, and finally performing the light on test on the open cell so as to wait to laminate the open cell with the touch panel to with the protection film.

In one or more embodiments, the above act of providing the touch panel with the protection film includes the following acts:

first performing an incoming quality inspection on a touch sensor chip incoming the factory and a cover glass incoming the factory, wherein the touch sensor chip is a chip assembled with sensor modules;

then unpacking the quality inspected touch sensor chip and the cover glass incoming the factory;

subsequently laminating the touch sensor chip incoming the factory with the cover glass incoming the factory to form the touch panel with the protection film; and

waiting to laminate the touch panel with the protection film with the open cell after the touch panel with the protection film is formed.

In one or more embodiments, the above act of providing the touch panel with the protection film includes the following acts:

first performing an incoming quality inspection on a touch sensor substrate incoming the factory and a cover glass incoming the factory, wherein the touch sensor substrate incoming the factory is an uncut substrate;

then unpacking the quality inspected touch sensor substrate and cover glass incoming the factory;

subsequently performing cutting, edging, anisotropic conductive film (ACF) paste, flexible printed circuit board (FPC) lamination and silicon coating on the touch sensor substrate in sequence to form the touch panel chip;

next laminating the touch panel chip with the cover glass to form the to touch panel with the protection film; and

waiting to laminate the touch panel with the protection film with the open cell after the touch panel with the protection film is formed.

In one or more embodiments, the above act of providing the touch panel with the protection film includes the following acts:

cutting a large piece of touch sensor substrate into plural small pieces of touch sensor chips;

then edging the small pieces of touch sensor chips;

then pasting anisotropic conductive films (ACFs) to the drive side of the small pieces of touch sensor chips;

next laminating flexible printed circuit boards (FPCs) to the drive sides of the small pieces of touch sensor chips;

next coating silicon onto the drive sides of the small pieces of touch sensor chips;

next pasting anisotropic conductive films (ACFs) to the sensor side of the small pieces of touch sensor chips;

then laminating flexible printed circuit boards (FPCs) to the sensor sides of the small pieces of touch sensor chips; and

coating silicon onto the sensor sides of the small pieces of touch sensor chips to form the touch panel chip.

In one or more embodiments, the above act of laminating the open cell with the touch panel with the protection film further includes the following acts:

providing the open cell;

providing the touch panel with the protection film formed by a lamination process in the factory; and

further laminating the open cell with the touch panel with the protection film to form the touch and display panel, wherein the abovementioned processes are all completed in the same factory area.

In one or more embodiments, the above mentioned lamination includes full lamination and conventional lamination through border adhesive.

In one or more embodiments, the act of integrating using the liquid crystal display module includes the following acts:

providing a backlight unit assembled in the factory;

providing a touch and display panel formed through a lamination process in the same factory; and

integrating the backlight unit with the touch and display panel using the liquid crystal display module to form the touch and display device, wherein all of the abovementioned processes are completed in the same factory area.

In one or more embodiments, the above act of integrating using the liquid crystal display module includes assembling components. The components include a housing case and a plurality of other components, which are assembled to form a display head of a notebook computer, i.e., the touch and display device.

In one or more embodiments, the acts of forming the touch panel with the protection film, laminating the open cell and the touch panel with the protection film, assembling the backlight unit and integrating the backlight unit with the touch and display panel are all completed in the same factory area.

### BRIEF DESCRIPTION OF THE DRAWINGS

FIG. 1 is a flow chart of backend process integration (BPI) and system to integration process of a touch and display device;

FIG. 2 is a flow chart of a manufacture method of the touch and display device of the first embodiment of the invention;

FIG. 3 is a flow chart of a manufacture method of the touch and display device of the second embodiment of the invention;

FIG. 4 is a flow chart of a manufacture method of the touch and display device of the third embodiment of the invention;

FIG. 5 is a manufacture flow chart of a manufacture method of the touch panel with the protection film of another embodiment;

FIG. 6 is a manufacture flow chart of a manufacture method of the open cell of the invention;

FIG. 7 is a manufacture flow chart of providing the touch panel with the protection film;

FIG. 8 is a manufacture flow chart of laminating;

FIG. 9 is a manufacture flow chart of integration using the liquid crystal display module; and

FIG. 10 is a manufacture flow chart of system assembling.

### DETAILED DESCRIPTION

A plurality of embodiments of the invention are disclosed below with reference to the drawings. For purpose of clear illustration, various details in practice will also be illustrated in the description below. However, it should be understood that the invention is not limited to these practical details. In other words, in some embodiments of the present invention these details in practice to are unnecessary. Furthermore, for purpose of simplifying the drawings, some conventional common structures and elements are illustrated in the drawings in a simply schematic manner.

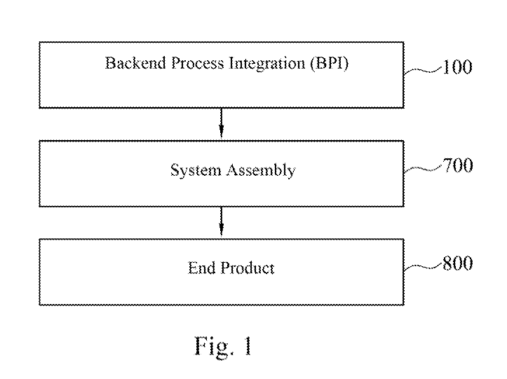

FIG. 1 is a flow chart of the backend process integration (BPI) and system integration process of a touch and display device. First as shown in FIG. 1, in the flow chart, backend process integration (BPI) is first performed (act 100). The BPI is mainly the manufacture processes of the touch and display device, which is described hereafter. A system assembling is performed (act 700) after the BPI (act 100). The finished product is further manufactured (act 800) mainly by performing system assembling (act 700) of the product of the BPI (act 100).

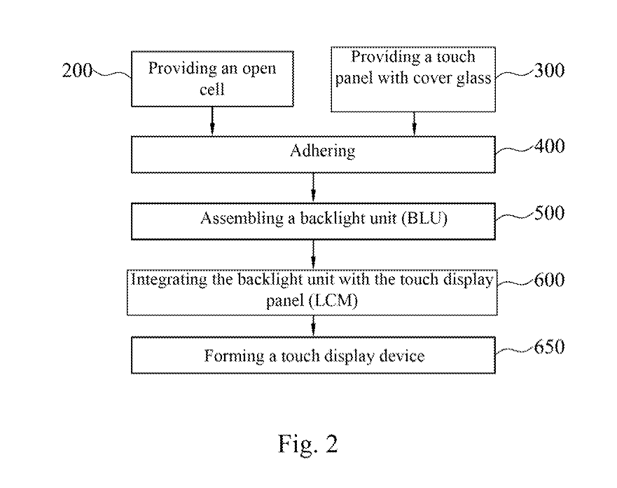

The BPI is described in details hereafter with reference to the system integration flow chart. Referring to FIG. 2, it is a flow chart of a manufacture method of the touch and display device of the first embodiment of the invention. First the BPI (act 100) is described in details. In the BPI process, first an open cell is provided (act 200), such as a liquid crystal panel, and then a touch panel with a protection film is provided (act 300). The actions of unpacking (or removing the protection film) and incoming quality inspecting are first performed before the open cell and the touch panel with the protection film are used, and then the open cell and the touch panel with the protection film are laminated (act 400). The lamination method may be full lamination or a conventional lamination method through border adhesive, etc, but herein it should be noted that the lamination specifically refers to the full lamination. The full lamination technology mainly pasting a cover glass (or a touch panel with the protection film) to the open cell with glue, wherein since the gap between the open cell and the cover glass (or the touch panel with the protection film) is of a vacuum state, the problem of light refraction can be avoided, while if the conventional lamination through border adhesive is applied, a ghost effect as two overlapped glass pieces may be easily caused. Furthermore, the full lamination can enable the screen to have a higher brightness and higher image quality, which improves the sense of reality, and even under the bright light outdoor, the display content on the screen of a mobile phone or a tablet computer can still be seen clearly. Subsequently, a backlight unit (BLU) is assembled (act 500), and then the BLU is integrated with the laminated open cell and touch panel with the protection film using a liquid crystal display module (act 600) to form a touch and display device (act 650). The above mentioned acts make up the BPI (act 100).

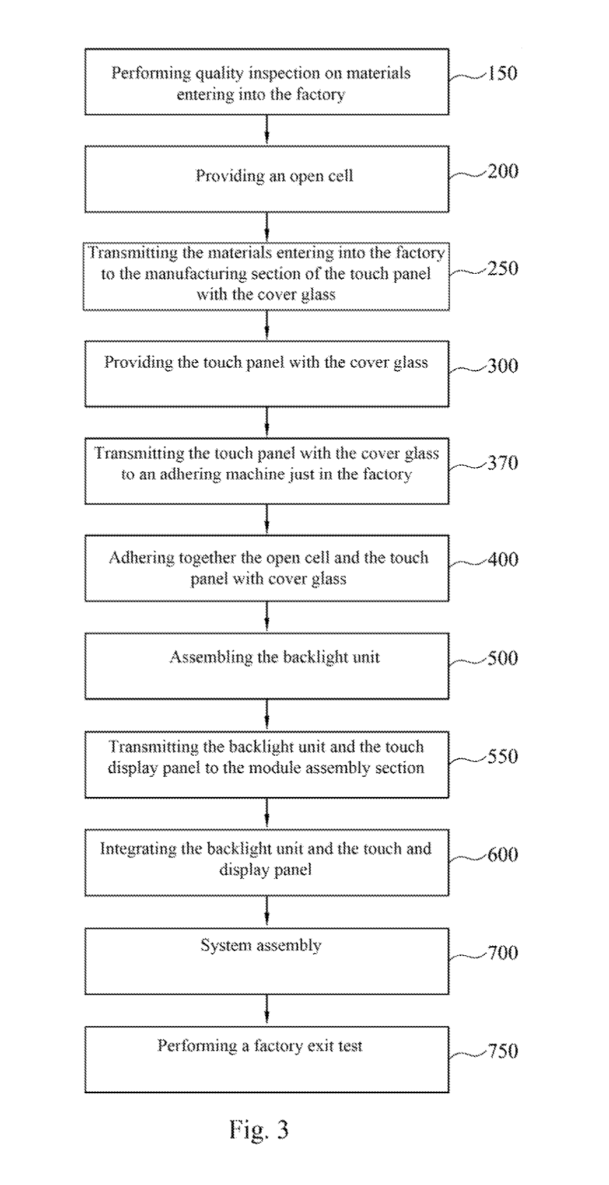

Particularly, referring to FIG. 3, it is a flow chart of a manufacture method of the touch and display device of the second embodiment of the invention. Since all the acts are performed in the same workshop, the manufacturer can first inspect the quality of materials incoming the factory before manufacturing the touch panel with the protection film (act 150). Therefore, the quality of the materials can be assured before start of manufacturing the touch and display device. Thereafter, the manufacturer provides the open cell (act 200). Generally, the open cell is directly bought from other manufacturers. However in one or more embodiments, the open cell can also just be manufactured in the factory, although the invention is not limited to this. Thereafter, the manufacturer can transmit the materials incoming the factory to the manufacture section of the touch panel with the protection film just in the factory, so as to manufacture the touch panel with the protection film (act 250). In other words, before manufacturing the touch panel with the protection film, the manufacturer first inspect all the materials used for manufacturing the touch panel with the protection film, which means that all the materials can be inspected by establishing only one quality control zone, so that the number of quality control zones is significantly decreased and the quality level of the materials can be managed conveniently. Then the manufacturer provides the touch panel with the protection film (act 300). The detailed content of the act of providing the touch panel with the protection film may be the conventional process content (described in details hereafter) and belongs to the scope of the invention. After the touch panel with the protection film is manufactured, the manufacturer can transmit the touch panel with the protection film to a lamination machine just in the factory, so as to laminate the open cell with the touch panel with the protection film (act 370).

Then the manufacturer can laminate the open cell with the touch panel with the protection film to form the touch and display panel (act 400). The abovementioned lamination method may be full lamination or a conventional lamination method through border adhesive, etc, but herein it should be noted that the lamination specifically refers to the full lamination. The full lamination technology mainly pasting a cover glass (or the touch panel with the protection film) to the open cell with glue, wherein since the gap between the open cell and the cover glass (or the touch panel with the protection film) is of a vacuum state, the problem of light refraction can be avoided, while if the conventional lamination through border adhesive is applied, a ghost effect as two overlapped glass pieces may be easily caused. Furthermore, the full lamination can enable the screen to have a higher brightness and higher image quality, which improves the sense of reality, and even under the bright light outdoor, the display content on the screen of a mobile phone or a tablet computer can still be seen clearly. After the touch and display panel is formed, the manufacturer subsequently assembly the backlight unit (BLU) (act 500). Then in the factory the backlight unit and the touch and display panel are transmitted to a module assembly section, so as to integrate the backlight unit and the touch and display panel (act 550). Then the manufacturer can integrate the backlight unit and the touch and display panel using the liquid crystal display module to form the touch and display device (act 600). By now, the main body of the touch and display device is manufactured. Thereafter, the manufacturer can perform system assembling of the touch and display device so as to form a display head (act 700). The display head is for example a tablet computer, a smart phone, a handheld device, a display head of a notebook computer, e.g. the Unifit Display (UD), or a notebook computer, but the invention is not limited to this. Thereafter, the manufacturer can perform out-going test on the display head (act 750). That is, a quality control zone can be arranged at this step, so as to perform out-going test on the touch and display device.

In view of the above, since with respect to the manufacture method of the touch and display device of the second embodiment of the invention, all the manufacture acts can be performed in the same workshop, for the factory end it is only needed to at least respectively arrange one quality control zone at the incoming factory material end and the out-going product end, and for the client end it is only needed to arrange one quality control zone at the out-going electronic device end so as to effectively achieve the purpose of quality control to and effectively reduce the labour power and cost of quality control. Furthermore, the above mentioned transmission method may for example manual handling and mechanical transmission (e.g., transmission through a band conveyer), which can both achieve the transmission purpose, but the invention is not limited to this.

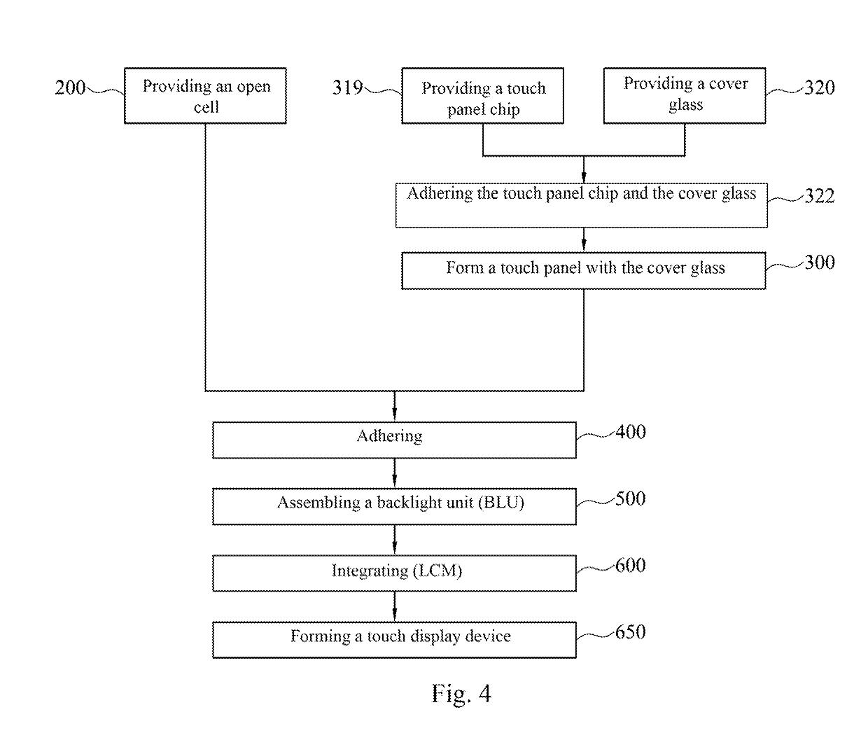

Then referring to FIG. 4, it is a flow chart of a manufacture method of the touch and display device of the third embodiment of the invention. First the BPI (act 100) is described in details with reference to another embodiment. The BPI process first provides a touch panel chip (act 319), wherein the touch panel chip is a cut touch panel chip provided with sensor modules. The acts of unpacking (or removing the protection film of) the touch panel chip incoming the factory and performing quality inspection on the same are performed before the touch panel chip is used, and then a cover glass is provided (act 320). Thereafter the cover glass and the touch panel chip are laminated (act 322) so as to form a touch panel with a protection film (act 300). The acts of unpacking (or removing the protection film of) the cover glass incoming the factory and performing quality inspection thereon are also performed before the cover glass is used, and an open cell is further provided (act 200), such as a liquid crystal panel, and then the open cell is laminated with the touch panel with the protection film (act 400). The abovementioned lamination method may be full lamination or a conventional lamination method through border adhesive, etc, but herein it should be noted that the lamination specifically refers to the full lamination. The full lamination technology mainly pasting the cover glass (or the touch panel with the protection film) to the open cell with glue, wherein since the gap between the open cell and the cover glass (or the touch panel with the protection film) is of a vacuum state, the problem of light refraction can be avoided, while if the conventional lamination through border adhesive is applied, a ghost effect as two overlapped glass pieces may be easily caused. Furthermore, the full lamination can enable the screen to have a higher brightness and higher image quality, which improves the sense of reality, and even under the bright light outdoor, the display content on the screen of a mobile phone or a tablet computer can still be seen clearly. Subsequently, a backlight unit (BLU) is assembled (act 500), and then the BLU is integrated with the laminated open cell and touch panel with the protection film using the liquid crystal display module (act 600) to form a touch and display device (act 650). The above mentioned acts make up the BPI (act 100).

In a conventional manufacture process, the backlight unit, the open cell and the touch panel with the protection film are generally first each manufactured in different workshops, and then are assembled together. Therefore, during the manufacture process, at least after the materials income the factory and before the products go out from the factory, it is inevitable that various quality control zones, unpacking/packing zones and cleaning zones should be arranged. In order to ensure a certain quality level of the semi-finished products in each manufacture process, the labour power cost, facility cost and the manufacture time are increased. Therefore, the cost for the quality control is huge. However, in the invention the abovementioned BPI process can be completed in the same factory area. Therefore, through the integration of processes in the same factory area, the transmission of semi-finished products can be operated through the transmission line in the factory, and even the number of times of the semi-finished products incoming/going out from the dust-free room can be reduced so as to reduce the use of packing materials, the labour power for packing and the packing time, and of course the number of processes of cleaning and baking of the semi-finished products before assembling is also reduced, and the number of incoming quality control (IQC) and out-going quality control (OQC) in the quality control zone is also reduced. This not only can help to reduce the labour power and cost with respect to quality control, but also can realize unified quality control, so that the quality controlled materials or finished products can have the same quality level, which improves the integration and reliability of the entire manufacture system.

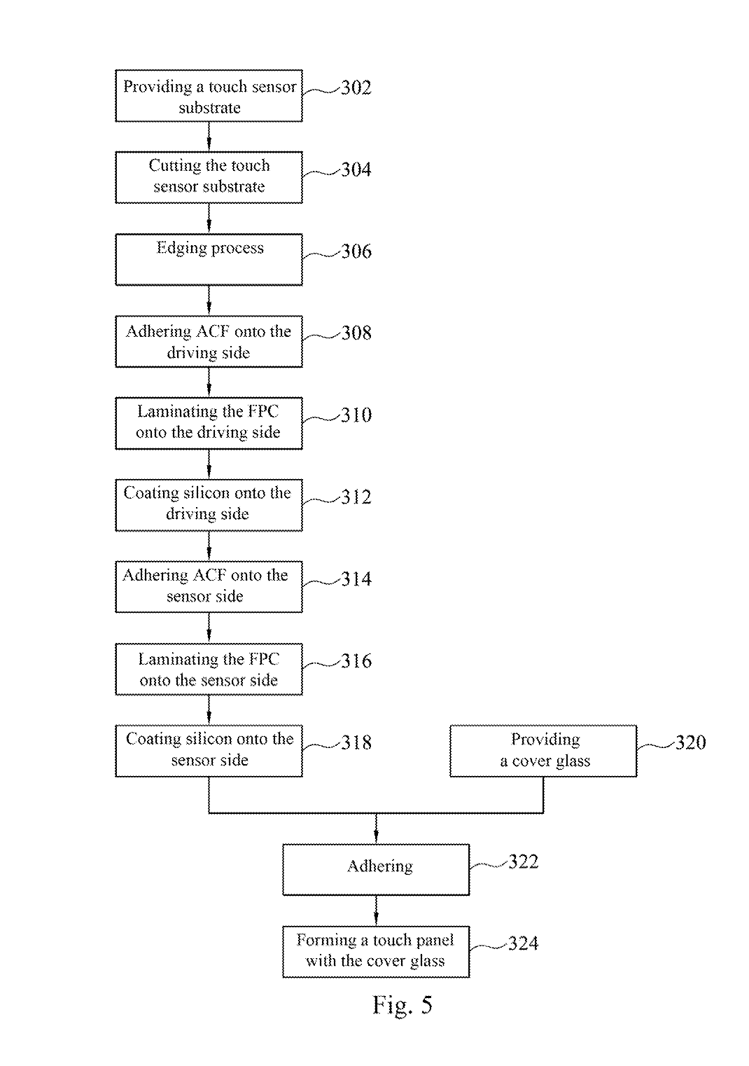

Then referring to FIG. 5, it is a flow chart of a manufacture method of the touch panel with the protection film of another embodiment. First the manufacturer provides a touch sensor substrate (act 302), wherein the touch sensor substrate is a large piece of uncut substrate. The acts of unpacking (or removing the protection film) and performing incoming quality control are first performed before the touch sensor substrate is used, and then the touch sensor substrate is cut to form a touch sensor chip (act 304). At this time, the touch sensor chip is a small chip, and then the touch sensor chip is edged (act 306). Subsequently the anisotropic conductive film (ACF) is pasted on the drive side (act 308). Through the function of ACF, the flexible printed circuit board (FPC) is laminated with the drive side (act 310), so that the FPC is partially communicated with the drive side of the touch sensor chip. Then silicon is coated on the drive side (act 312) to form a protection film. After the abovementioned acts are completed, the touch sensor chip is turned over, and then the ACF is pasted on the sensor side (act 314). Through the function of ACF, the FPC is laminated with the sensor side (act 316). Then silicon is coated on the sensor side (act 318) to form a touch panel chip. At this time, a cover glass is further provided (act 320) to be laminated with the touch panel chip (act 322) to form a touch panel with a protection film.

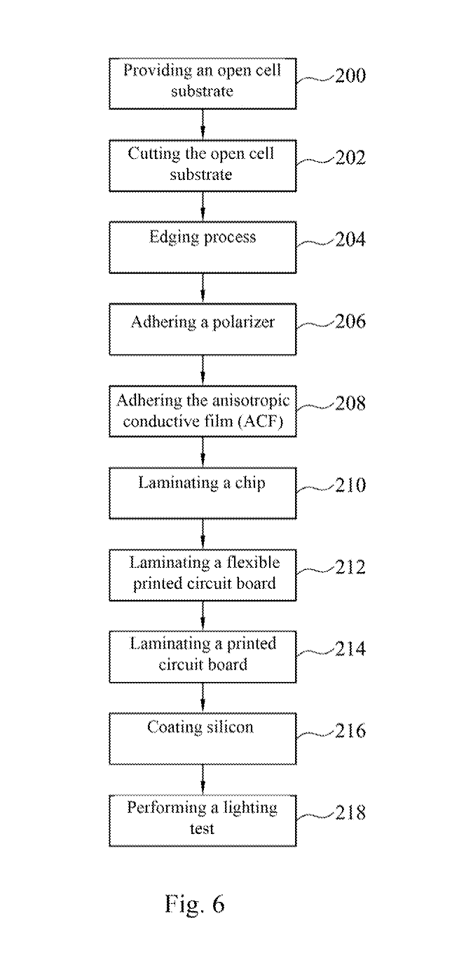

However as described above, the open cell may be a large piece of uncut open cell substrate or a small piece of cut open cell chip. The small piece of cut open cell chip is an open cell chip attached with a driving integrated circuit (IC), a FPC, a printed circuit board (PCB) and so on, not including the backlight unit. The process of producing the large piece of open cell substrate into small pieces of open cell chips is described in details hereafter. As shown in FIG. 6, it is a manufacture flow chart of the open cell of the invention. First an open cell substrate is provided (act 200), wherein the open cell substrate is a large piece of uncut open cell substrate. The acts of unpacking (or removing the protection film) and performing the incoming quality inspection are performed first before the open cell substrate is used, and then the open cell substrate is cut into small pieces of open cell chips (act 202). Then the small pieces of cut open cell chips are edged (act 204) to increase the transverse strength of the open cell chip. Thereafter the open cell chip is cleaned and a polarizer is pasted thereon (act 206). Subsequently the ACF is pasted on the open cell chip (act 208), and then the driving chip is laminated on the open cell chip (the chip on glass process) (act 210). Next the FPC is laminated on the open cell chip (the chip on film process) (act 212), then the PCB is laminated on the open cell chip (act 214). Finally the silicon is coated on the open cell chip (act 216) and the light on test is completed (act 218) to wait to laminate the open cell chip with the touch panel with the protection film.

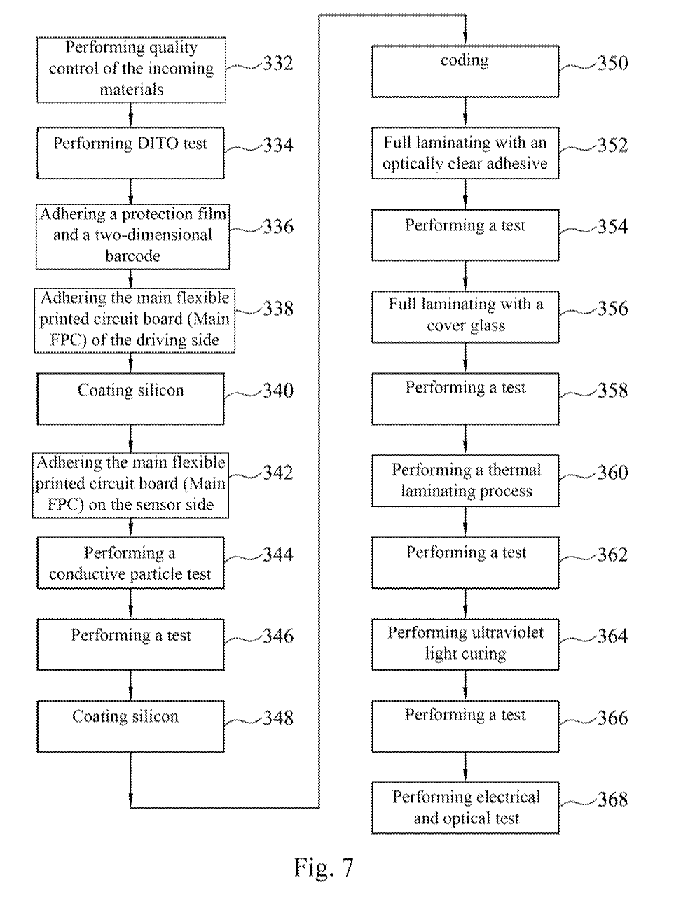

Then referring to FIG. 7, it is a manufacture flow chart of providing the touch panel with the protection film. During the process of manufacturing the touch panel with the protection film, the quality control of the incoming materials is first performed (act 332). After the materials are unpacked, a test is performed on a Double indium titanium oxide (DITO) layer (act 334). The DITO layer can be used as the sensor film of the touch panel with the protection film. Thereafter the manufacturer can first paste the protection film to the DITO layer, and then paste a two-dimensional barcode to the DITO layer (act 336). The two-dimensional barcode can be used to identify the DITO layer. Then the manufacturer can first paste the main flexible printed circuit board (Main FPC) of the drive side to the DITO layer (act 338). In particular, the manufacturer can first paste a layer of conducive adhesive to the DITO layer, and then the Main FPC of the drive side can be electrically connected to the DITO layer through the conducive adhesive. Thereafter, silicon is coated on the Main FPC of the drive side (act 340) so as to protect the circuits on the Main FPC of the drive side. Then the manufacturer can paste the Main FPC of the sensor side to the DITO layer (act 342). Similarly, the Main FPC of the sensor side can be electrically connected to the DITO layer through the conducive adhesive. Next a conductive ball test is performed (act 344). The test mainly detects the balls failure condition of the conductive balls, i.e., detecting the connection condition between the sensor side and the FPC. Then at this time the manufacturer can test whether the bonding is successful (act 346), for example testing the electrical connection between the FPC and the DITO layer. After the test is completed, the silicon is coated on the Main FPC of the sensor side (act 348) so as to protect the Main FPC of the sensor side.

Subsequently the DITO layer is laminated with a cover glass (CG). In particular, the DITO layer may first be kitted (act 350). The kitting process can eliminate poor DITO layers. Then an optically clear adhesive (OCA) is conformal coated on the DITO layer (act 352). Before the coating, the OCA should be first cleaned. Then the DITO layer is inspected again (act 354). Next, the DITO layer is laminated with the cover glass (act 356). In particular, first the cover glass is unpacked and cleaned automatically, and then the cleaned protection film is attached on the cover glass to kit the cover glass. The kitting cover glass is then laminated with the DITO layer. After the lamination, another inspection is performed again (act 358). The thermal pressing is performed to further laminate the cover glass with the DITO layer (act 360). Thereafter another inspection is performed again (act 362). The inspection mainly detect whether a dent waviness condition occurs between the cover glass and the DITO layer. Then the manufacturer can perform the ultraviolet light curing to cure the OCA (act 364). In order to make the optical character more stable, the ultraviolet light should irradiate the lamination face from the front face and the side faces. At this time, another inspection can be performed again (act 366), which mainly detects whether the waviness overflow crack condition occurs to the cover glass and the DITO layer. After the inspection is completed, at this time the manufacturer can perform a panel test of the laminated cover glass and DITO layer (act 368). Thus, the touch panel with the protection film is manufactured completely.

In order to improve the manufacture efficiency of the manufacture process of the touch panel, the manufacturer can arrange quality control points at act 348, act 354 and act 358, and for example a manufacturing execution system (MES) is used to inspect and record the fraction defective of semi-finished products, but the invention is not limited to this.

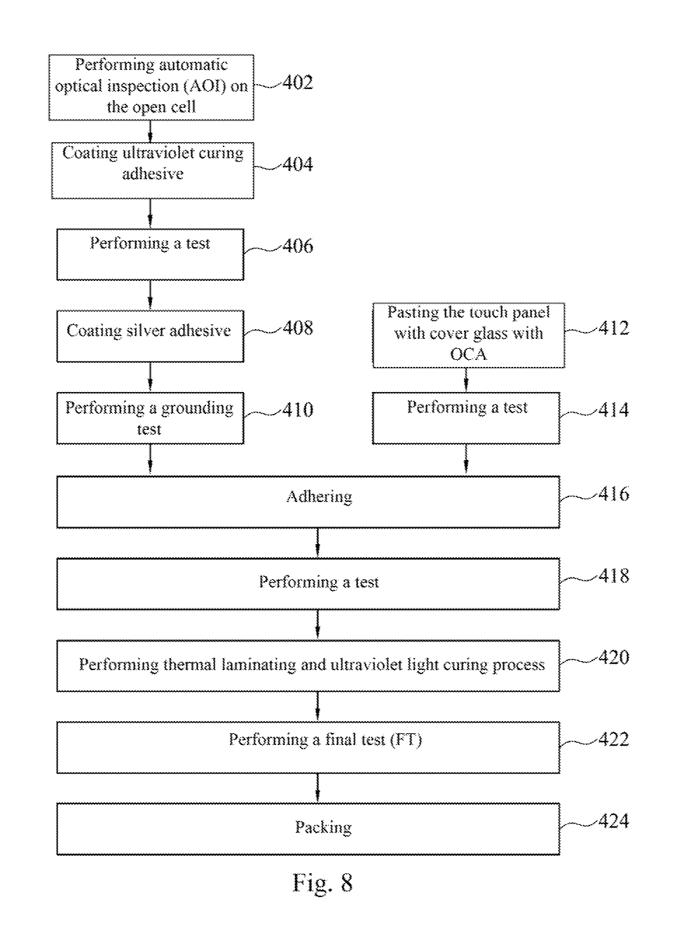

Then referring to FIG. 8, it is a manufacture flow chart of laminating. After the touch panel with the protection film is formed and the touch panel with the protection film is transmitted to the lamination machine, so as to start the manufacture of the touch and display panel. In particular, automatic optical inspection (AOI) is first performed on the open cell (act 402). Subsequently the ultraviolet Iglue is coated on the open cell (act 404), and then an inspection is performed again (act 406). The inspection item includes light leakage inspection. Next, after the silver glue is dispensed on the open cell (act 408) 24) and a ground test (a ground tape attachment) is performed thereon (act 410), the open cell is laminated with the touch panel with the protection film.

Additionally, the touch panel with the protection film can be laminated with the OCA again (act 412) only after the test and then an inspection is further performed (act 414). Thereafter the touch panel with the protection film is laminated with the open cell through the OCA (act 416). After the lamination, the touch and display panel is formed, and at this time, another inspection should be performed on the touch and display panel (act 418). Thereafter, the adhesion degree of the OCA is strengthened through the thermal pressing and another ultraviolet light curing process (act 420). Thus, the lamination process of the touch and display panel is completed.

Thereafter a series of final testing processes of the touch and display panel before packing is followed (act 422). In particular, the light on test, barcode link process and laser printing can be first performed on the touch panel with the protection film. Then after the touch panel with the protection film is in a no-operational storage for 24 hours, the final test (FT) and final visual (FV) are performed. The testing content is for example testing whether the appearances of the FPC, protection film and two-dimensional barcode are complete. Then after the quality final visual and quality final test (QFV/QFT) and the out-going quality control (OQC), the act of packing (PKG) is performed (act 424). The PKG content includes model number, workflow, part number and packing level classification.

Similarly, in order to improve the manufacture efficiency of the manufacture process of the touch panel with the protection film, the manufacturer can arrange quality control points at act 418 and when the barcode link and laser printing are performed, and for example a manufacturing execution system (MES) is used to detect and record the fraction defective of semi-finished products, but the invention is not limited to this.

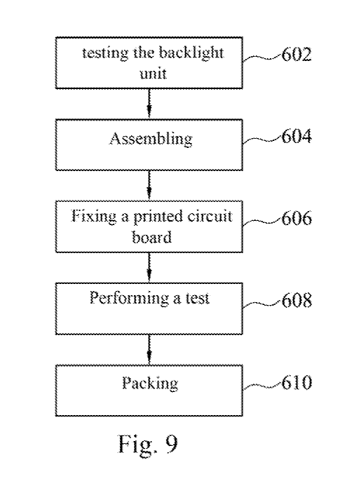

Then referring to FIG. 9, it is a manufacture flow chart of integration. After the touch and display panel is formed, the manufacturer can transmit both the touch and display panel and the backlight unit to the process of module assembly to integrate the touch and display panel and the backlight unit using the liquid crystal display module. In particular, before the integration, the backlight unit should be first inspected (act 602), and then the backlight unit is integrated with the touch and display panel (act 604). Thus the assembly of the touch and display device is completed. Thereafter, the manufacturer can fix the PCB on the touch and display device (act 606). Then the manufacturer can perform a series of inspections on the touch and display device (act 608). The inspection items are sequentially the assembly test (AST), the aging test, the FT, the FV, the final quality control (FQC) and the light leakage inspection. The process of aging test is operating the laminated touch and display device under a high temperature for several hours to accelerate the aging of the panel. Since the broken speed of defective parts of the defective product is accelerated under the high temperature, the aging test can help to find out the defective product early. After the test is completed, the manufacturer can perform the packing process (act 610).

Similarly, in order to improve the manufacture efficiency of the manufacture process of the touch and display device, the manufacturer can arrange quality control points at assembly test (AST) and act 610, and for example a manufacturing execution system (MES) is used to detect and record the fraction defective of semi-finished products, but the invention is not limited to this.

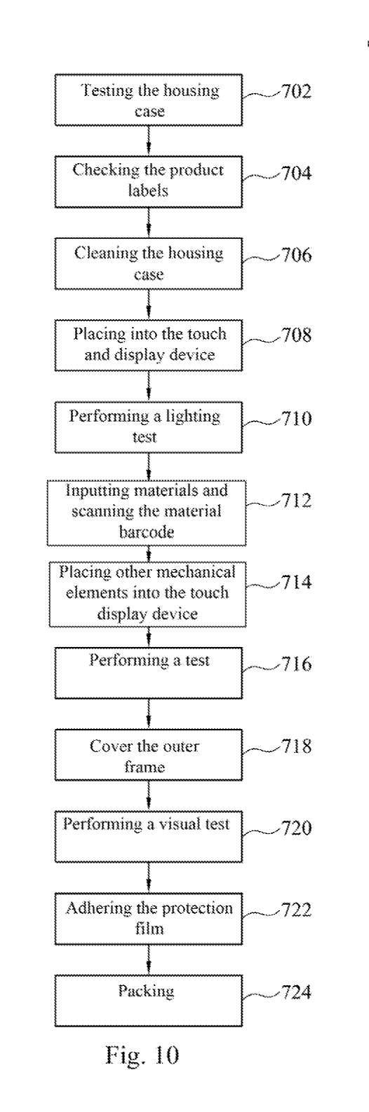

Then referring to FIG. 10, it is a manufacture flow chart of system assembly. In one or more embodiments, the display head is for example the display head of a notebook computer. In particular, the manufacturer can first provide a housing case of the display head which has an accommodation space, so as to accommodate the touch and display device and several elements. First the manufacturer inspects the housing case (act 702) and checks the product logos (act 704). Then the manufacturer cleans the housing case (act 706) to ensure that the housing case is clean. Then the touch and display device is placed into the housing case (act 708).

After the touch and display device is placed into the housing case, the manufacturer should first perform a light on test (act 710). Then the materials are inputted and the barcode of the materials are scanned (act 712). Thereafter other elements are placed into the housing case (act 714). In to particular, the manufacturer can sequentially place a light-emitting diode bar cable, a PCB, a camera, a camera cable, a wireless network module, trims and clutch barrels into the housing case. Thus the elements assembly of the display head is completed. Then the manufacturer performs respective tests on the above elements (act 716), such as the electrical test, the camera test, the voltage standing wave ratio (VSWR) test and the open cell test. After these tests, the manufacturer can assemble the bezel (act 718), and thus the assembly of the touch and display device is completed. Next after a series of cosmetic tests (act 720), a protection film can be pasted onto the touch and display device (act 722) to complete packing (act 724) and then prepare for shipment.

The manufacturer can set an electronic posting system at the acts 712, 714, 716 and 624, and for example a shop floor control (SFC) system is used to manage the elements, but the invention is not limited to this.

Although the present invention has been disclosed with reference to the above embodiments, these embodiments are not intended to limit the present invention. It will be apparent to those of skills in the art that various modifications and variations can be made without departing from the spirit and scope of the present invention. Therefore, the scope of the present invention shall be defined by the appended claims.

1. A manufacturing method of a touch display device, comprising:
providing an open cell;
providing a touch panel with a cover glass;
adhering together the open cell and the touch panel with the cover glass to form a touch display panel; and
assembling a backlight unit (BLU), and then performing a liquid crystal display module (LCM) process by integrating the backlight unit and the touch display panel to form a touch display device.

2. The manufacturing method of the touch display device of claim 1, wherein the step of providing the open cell comprises:
performing an incoming quality inspection on an open cell chip entering into a factory, wherein the open cell chip is a cut open cell chip adhered with a driving chip, a flexible printed circuit board (FPC), and a printed circuit board (PCB); and
unpacking the open cell chip, which has undergone quality inspection, and waiting for adhering together with the touch panel with the cover glass.

3. The manufacturing method of the touch display device of claim 2, wherein the step of adhering comprises full lamination and conventional adhering using an adhesive.

4. The manufacturing method of the touch display device of claim 1, wherein the step of providing the open cell comprises:
performing an incoming quality inspection on an open cell substrate entering into a factory, wherein the open cell substrate is an uncut open cell substrate;
cutting, performing an edging process on, and cleaning the open cell substrate, which has undergone quality inspection, and then adhering a polarizer onto the open cell substrate; and
performing in sequence adhering of an anisotropic conductive film (ACF), laminating of a chip on glass (COG), laminating of a chip on film (COF), laminating of a printed circuit board (PCB), completing a lighting test after a coating of silicon, and waiting for adhering together with the touch panel with the cover glass.

5. The manufacturing method of the touch display device of claim 4, wherein the step of adhering comprises full lamination and conventional adhering using an adhesive.

6. The manufacturing method of the touch display device of claim 1, wherein the step of providing the touch panel with the cover glass comprises:
performing an incoming quality inspection on a touch sensor chip and a cover glass entering into a factory, wherein the touch sensor chip is a chip completed with an assembly of a touch module;
unpacking the touch sensor chip and the cover glass which have undergone quality inspection;
adhering together the touch sensor chip and the cover glass to form the touch panel with the cover glass; and
waiting for adhering together the touch panel with the cover glass and the open cell after the completion of the touch panel with the cover glass.

7. The manufacturing method of the touch display device of claim 6, wherein the step of adhering comprises full lamination and conventional adhering using an adhesive.

8. The manufacturing method of the touch display device of claim 1, wherein the step of providing the touch panel with the cover glass comprises:
performing an incoming quality inspection on a touch sensor substrate and a cover glass entering into a factory, wherein the touch sensor substrate is an uncut substrate;
unpacking the touch sensor substrate and the cover glass which have under one quality inspection;
performing in sequence cutting, an edging, process, adhering together of an anisotropic conductive film (ACF), laminating a flexible printed circuit board (FPC), and completing a touch panel chip after the coating of silicon;
adhering together the touch panel chip and the cover glass to form the touch panel with the cover glass; and
waiting for adhering together the touch panel with the cover glass and the open cell after the completion of the touch panel with the cover glass.

9. The manufacturing method of the touch display device of claim 8, wherein the step of adhering comprises full lamination and conventional adhering using an adhesive.

10. The manufacturing method of the touch display device of claim 8, wherein the step of providing the touch panel with the cover glass further comprises:
cutting a touch sensor substrate into a plurality of touch sensor chips;
performing an edging process on the touch sensor chips;
adhering the anisotropic conductive films (ACFs) to the driving sides of the touch sensor chips;
laminating the flexible printed circuit boards (FPCs) to the driving sides of the touch sensor chips;
coating silicon onto the driving sides of the touch sensor chips;
adhering the anisotropic conductive films (ACFs) to the sensor sides of the touch sensor chips;
laminating the flexible printed circuit boards (FPCs) to the sensor sides of the touch sensor chips; and
coating silicon onto the sensor sides of the touch sensor chips to form the touch panel chips.

11. The manufacturing method of the touch display device of claim 1, wherein the step of adhering together the open cell and the touch panel with the cover glass further comprises:
providing the open cell;
providing the touch panel with the cover glass completed by adhering together the same in a factory; and
adhering together the open cell with the touch panel with the cover glass to form the touch display panel, wherein all the manufacturing processes are completed in the same factory.

12. The manufacturing method of the touch display device of claim 11, wherein the step of adhering comprises full lamination and conventional adhering using an adhesive.

13. The manufacturing method of the touch display device of claim 1, wherein the step of adhering comprises full lamination and conventional adhering using an adhesive.

14. The manufacturing method of the touch display device of claim 1, wherein the step of performing the liquid crystal display module process comprises:
providing the backlight unit which is assembled in the factory;
providing the touch display panel which is adhered together in the factory; and
assembling the liquid crystal display module (LCM) by integrating the backlight unit and the touch display panel to form the touch display device, wherein all the manufacturing processes are completed in the same factory.

15. The manufacturing method of the touch display device of claim 1, wherein the step of performing the liquid crystal display module process further comprises assembling mechanical components, the mechanical components composing a housing case and a plurality of mechanical elements, so as to perform assembly to form a display head of a notebook computer, the display head being the touch display device.

16. The manufacturing method of the touch display device of claim 1, wherein the steps of providing the touch panel with the cover glass, adhering together the open cell and the touch panel with the cover glass, assembling the backlight unit and performing the assembly by integration are completed in the same factory area.
